(19) United States
(12) Patent Application Publication
(10) Pub. No.: US 2017/0007376 A1
(43) Pub. Date: Jan. 12, 2017

(54) Dental Impression Acquisition Tray

(71) Applicant: BeakJin Kim, Seoul (KR)

(72) Inventor: BeakJin Kim, Seoul (KR)

(21) Appl. No.: 14/795,355

(22) Filed: Jul. 9, 2015

(51) Int. Cl. A61C 9/00

(52) U.S. Cl. CPC A61C 9/0006

(57) ABSTRACT

The present invention provides a dental impression acquisition tray that includes: a handle; a dental acquisition frame including a first extending from an end of the handle, a second part opposite the first part, and a middle connection part connecting the first part and the second part to each other; a dental acquisition film disposed in a space inside the dental acquisition frame; and a reinforcing member extending along the dental acquisition frame, inserted in the first part and the second part, and exposed to the outside at the middle connection part, in which a plurality of grooves is formed in the first part and the second part.

### BACKGROUND OF THE INVENTION

Field of the Invention

The present invention relates to a dental impression acquisition tray that can acquire accurate dental impression without being damaged by keeping a deformed state, even if it deformed, such as twisting, by the state of the mouth of a dental patient.

Description of the Related Art

In order to make a prosthesis for a dental patient, it is required to acquire a dental impression of the mouth of the patient. A dental impression acquisition tray is an article used in this case.

A dental impression acquisition tray 1 of the related art is composed of handle 2 and a structure 2 connected with one end of the handle 2 and fixing an acquisition membrane 3 containing an impression material. Disposable products are generally used for the handle 2 and structure 4 of the dental impression acquisition tray 1 for the convenience, and plastic materials that are cheap is usually used for the features of disposable products.

When a dental patient bites the dental impression acquisition tray 1, the intact dental impression of the patient is supposed to be acquired. However, when a dental patient who has a left-right or up-down asymmetric mouth structure bites the dental impression acquisition tray 1 for acquiring dental impression, force is not uniformly applied to the entire tray, for example, a larger force is applied to a predetermined portion of the tray, so the structure 4 is deformed, such as twisting, in many cases. Further, when some of dental patients have peculiar dental impression, it is impossible to acquire accurate dental impression with the dental impression acquisition tray 1 of the related art. This is because when a patient has a peculiar dental impression, he/she has to bite the dental impression acquisition tray 1 with a larger force, and accordingly, the structure 4 is largely deformed and may be damaged or broken by deformation at a predetermined level or more, because it is made of plastic.

Further, the frame of the dental impression acquisition tray 1 of the related art always deforms a little with the impression material in the process of acquiring dental impression. However, the frame of the dental impression acquisition tray 1 of the related art is made of plastic, so it returns to the original shape and the impression material is additionally deformed in the process of returning, so acquisition accuracy of the impression material is deteriorated.

The plastic dental impression acquisition tray 1 of the related art is damaged due to unbalanced force. Alternatively, the dental impression acquisition tray 1 deforms and returns to the original shape due to the elasticity of the plastic structure 4 itself, so the intact dental impression of a dental patient cannot be acquired in this case either.

### SUMMARY OF THE INVENTION

Accordingly, the present invention has been made keeping in mind the above problems occurring in the related art, and the present invention is intended to propose a dental impression acquisition tray that can acquire accurate dental impression without being damaged by keeping a deformed state, even if it deformed, such as twisting, by the state of the mouth of a dental patient.

In order to achieve the above object, according to one aspect of the present invention, there is provided a dental impression acquisition tray that includes: a handle; a dental acquisition frame including a first part connected with the handle and a second part opposite the first part; a reinforcing member connecting the first part and the second part to each other; and a dental acquisition film disposed in a space inside the dental acquisition frame and covered with an impression film. The reinforcing member may be partially inserted in the first part and the second part and the reinforcing member may be made of metal. The first part and the second part each may have a core covering a portion of the reinforcing member and a plurality of nodes formed on a top and a bottom of the core, and a plurality of grooves may be formed between the nodes.

A length of the portion of the reinforcing member inserted in the first part may be ⅓ or more of a length of the first part, and a length of the reinforcing member inserted in the second part may be ⅓ or more of a length of the second part.

A width of the grooves may be 1mm to 3mm in an extension direction of the first part or the second part.

The number of the nodes of the first part may be six to eight on each of the top and the bottom of the core, and the number of the nodes of the second part may be four to six on each of the top and the bottom of the core.

Lengths of the nodes of the first part and the nodes of the second part may be 0.8 cm-2 cm in an extension direction of the dental acquisition frame.

The nodes of the first part and the second part each may have a protrusion that protrudes inward.

According to another aspect of the present invention, there is provided a dental impression acquisition tray that includes: a handle; a dental acquisition frame including a first part extending in two directions from an end of the handle and a second part opposite the first part; a first reinforcing member connecting a first end of the first part and a first end of second part to each other and a second reinforcing member connecting a second end of the first part and a second end of the second part to each other; and a dental acquisition frame disposed in a space inside the dental acquisition frame and covered with an impression material. The first reinforcing member may be partially inserted in the first part and the second part, the second reinforcing member may be partially inserted in the first part and the second part, the first reinforcing member and the second reinforcing member may be made of metal. The first part and the second part each may have a core partially covering the first reinforcing member or the second reinforcing member and a plurality of nodes formed on a top and a bottom of the core, and a plurality of grooves may be formed between the nodes.

The second part may have a U-shape.

A length of the portion of the first reinforcing member inserted in the first part may be ¼ or more of a length of the first part, a length of the second reinforcing member inserted in the first part may be ¼ or more of the length of the first part, a length of the portion of the first reinforcing member inserted in the second part is ¼ or more of a length of the second part, and a length of the portion of the second reinforcing member inserted in the second part may be ¼ or more of the length of the second part.

According to the dental impression acquisition tray having the configuration, the frame is not damaged, even if it is distorted, so it is possible to more acquire accurate dental impression.

Further, according to the present invention, even if the frame deforms when dental impression is acquired, the frame can naturally deform to fit the teeth arrangement of a patient without being damaged and the frame and the impression material of the dental impression acquisition tray can be maintained in the deformed shape, so an accurate dental impression can be acquired.

Further, according to the present invention, even if force is not uniformly applied to the dental impression acquisition tray, for example, a larger force is applied to some of the dental impression acquisition tray, due to severe left-right or up-down asymmetry of teeth, it is possible to acquire accurate dental impression of a patient.

Further, according to the present invention, it is possible to acquire accurate dental impression, even if a patient has peculiar teeth arrangement and bites the dental impression acquisition tray with a force larger than in a normal case.

Further, according to the present invention, since the frame and the impression material of the dental impression acquisition tray are not additionally deformed, it is possible to acquire a more accurate dental impression of a patient.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 shows a dental impression acquisition tray of the related art;

FIG. 2 is a perspective view of a dental impression acquisition tray according to an embodiment of the present invention;

FIG. 3 is a plan view of the a dental impression acquisition tray shown in FIG. 2;

FIG. 4 is a partial enlarged view the portion A of FIG. 3;

FIG. 5 is a side view showing a first part of FIG. 2; and

FIG. 6 is a perspective view of a dental impression acquisition tray according to another embodiment of the present invention.

### DETAILED DESCRIPTION OF THE INVENTION

A dental impression acquisition tray 10 according to the present invention is described hereafter in detail with reference to the accompanying drawings.

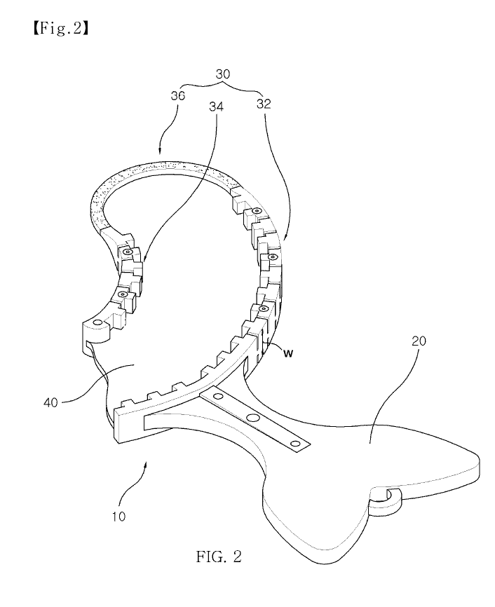

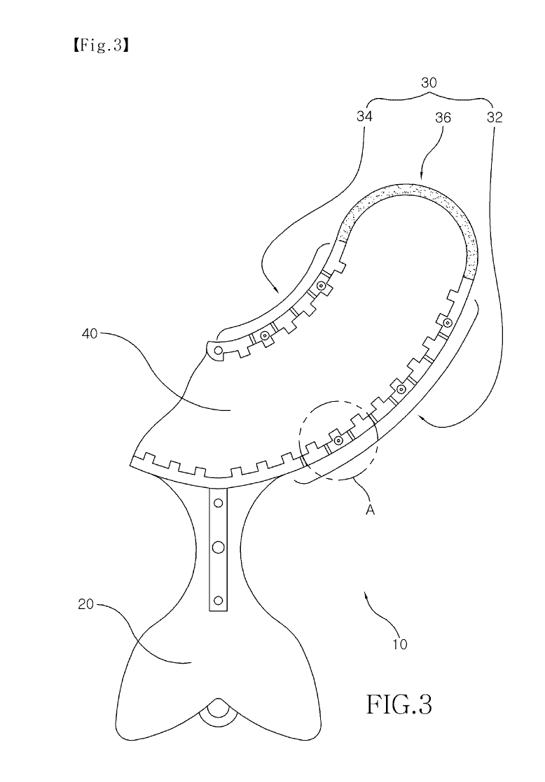

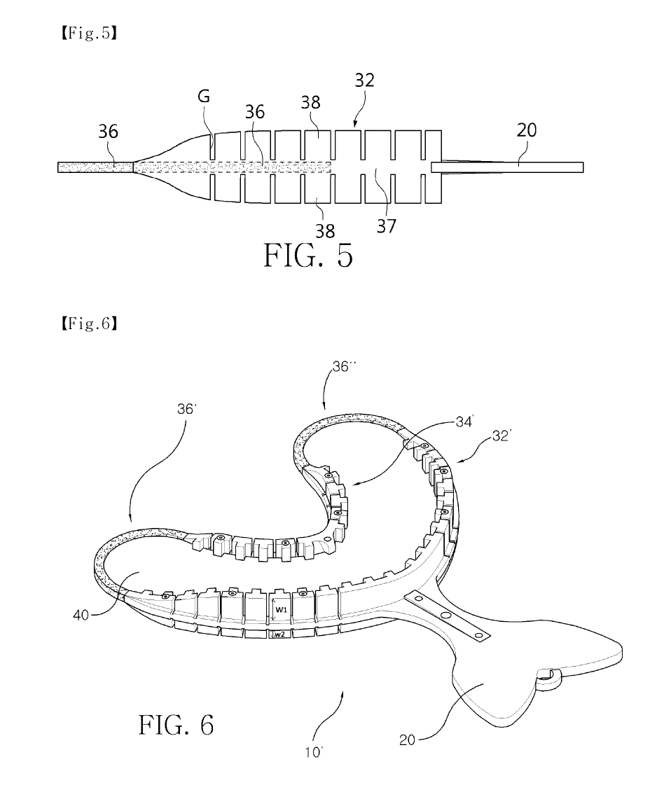

FIGS. 2 and 3 are a perspective view and a plan view, respectively, of a dental impression acquisition tray 10 according to an embodiment of the present invention. FIG. 5 is a side view showing a first part, that is, the right side in FIG. 2

Referring to FIG. 2, the dental impression acquisition tray 10 according to the present invention may have a handle 20 that a dental patient etc. holds.

A dental acquisition frame 30 is connected to an end of the handle 20. The dental acquisition frame 30 may be composed of a first part 32 connected to the handle 20, a second part 34 opposite the first part 32, and a reinforcing member 36 bending and connecting the first part 32 and the second part 34 to each other. The dental acquisition frame 30 may be made of plastic, but it is not limited thereto and may be made of other materials having the same properties as plastic.

The width W of the first part 32 may be substantially uniform to a predetermined distance from the joint with the handle 20 and gradually decreases at the portion close to the reinforcing member 36, as it goes to the reinforcing member 36. The predetermined distance may be 60-70% of the entire length of the first part 32. When the predetermined distance is less than 60%, it causes a problem with the entire strength of the dental acquisition frame 30, and when it is larger than 70%, a dental patient feels inconvenient when he/she bites it.

A dental acquisition film 40 may be disposed in the space defined inside by the first part 32, second part 34, and reinforcing member 36 of the dental acquisition frame 30. The dental acquisition film 40 may be a thin membrane made of a textile. A dental impression material is applied to the top and the bottom of the dental acquisition film 40 in order to acquire dental impression, and when a dental patient bites the dental impression acquisition material, dental impression is acquired.

In the reinforcing member 36, the center portion bends to connect the first part 32 and the second part 34 to each other and some portions including both ends may be inserted in the first part 32 and the second part 34. In detail, an end of the reinforcing member 36 may be inserted in the first part 32 through the portion, which is farther from the handle 20, of the first part 32 Further, the other end of the reinforcing member 36 may be inserted in the second part 34 through an end of the second part 34.

The reinforcing member 36 may be made of metal. In detail, the reinforcing member 36 may be made of metal, copper, brass, aluminum, and an alloy that maintain a deformation shape after being deformed.

The reinforcing member may be made of a shape memory alloy. In detail, the reinforcing member 36 may be made of alloys of Cu—Zn—Ni, Cu—Al—Ni, Ag—Ni, and Au—Cd alloys obtained by mixing an Ni-based, Cu-based, and Fe-based metal with metal such as zinc (Zn), aluminum (Al), gold (Au), and silver (Ag). Further, the reinforcing member 36 may be made of a Ni-Ti alloy.

Accordingly, when the dental impression acquisition tray 10 deforms due to the mouth structure of a dental patient, unlike plastic that returns to the shape before deformation by elasticity, the reinforcing member 36 made of metal can maintain the deformed shape, so an accurate impression of the mouth structure of a dental patient can be acquired. Further, since the reinforcing member 36 made of metal is not easily broken, unlike plastic, the possibility of damage to the dental impression acquisition tray 10 can be considerably reduced in dental impression acquisition.

In order to effectively maintain deformation, the lengths of the portions of the reinforcing member 36 that are inserted in the first part 32 and the second part 34 should be ⅓ or more of the lengths of the first part 32 and the second part 34, or may be ½ or more of the lengths of the first part 32 and the second part 34. Alternatively, the reinforcing member 36 may be inserted up to the portions where nodes 38 of the first part 32 and the second part 34 are formed.

If the reinforcing member 36 is shorter than ⅓ of the lengths of the first part 32 and the second part 34, deformation at the portion where the reinforcing member 36 is not inserted cannot be sufficiently maintained.

The structure of the dental acquisition frame 30 of the present embodiment is described in more detail with reference to FIGS. 2 to 4. The first part 32 and the second part 34 of the dental acquisition frame 30 may have a core 37 covering the reinforcing member 36 and a plurality of nodes 38 at both sides of the core 37. Although FIG. 5 shows a side of the first part 32, the second part 34 basically has the same configuration as the first part 32 shown in FIG. 5, except for the number of the nodes.

The nodes 38 are arranged with regular intervals in a line in the extension direction of the first part 32 and the second part 34. Six to eight nodes may be formed on each of both sides of the first part 32 and four to six nodes may be formed on each of both sides of the second part 34.

In other words, a plurality of grooves G is formed with regular intervals between the nodes in the first part 32 and the second part 34 of the dental acquisition frame 30. The reinforcing member 36 inserted in the first part 32 and the second part 34 may be exposed at the portions where the grooves G are formed.

Since the dental acquisition frame 30 is formed in this structure, the nodes 38 freely deform when the reinforcing member 36 deforms, so the first pat 32 and the second part 34 can also freely deform. That is, when a dental patient bites the dental impression acquisition tray 10, the dental acquisition frame 30 can freely deform with the reinforcing member 36 to fit the mouth structure of the patient. Further, the deformed dental acquisition frame 30 is maintained in the deformed shape by the metallic reinforcing member, and similarly, the impression material deformed by teeth of the patient can also be maintained in the deformed shape.

The gap between adjacent nodes, that is, the length of the groove G may be within the range of 1 mm to 3 mm in the extension direction of the dental acquisition frame 30. If the length of the groove G is less than 1 mm, the adjacent nodes hits against each other while the dental acquisition frame 30 deforms, so the dental acquisition frame 30 may be damaged or may deform differently from the mouth structure of a dental patient. If the length of the groove G is larger than 3 mm, a problem may be caused in strength of the dental acquisition frame 30 and the portion supporting the dental acquisition film 40 is reduced, so the dental acquisition form 40 may be separated from the dental acquisition frame 30.

The length of the nodes 38, that is, the gap between the grooves may be within the range of 0.8 cm to 2 cm in the extension direction of the dental acquisition frame 30. When the length of the nodes 38 is smaller than 0.8 cm, the number of nodes 38 increases too much, so the manufacturing process becomes difficult. In contrast, when the length of the nodes 38 is larger than 2 cm, the nodes 38 are too long, so it may interfere with free deformation of the reinforcing member 36.

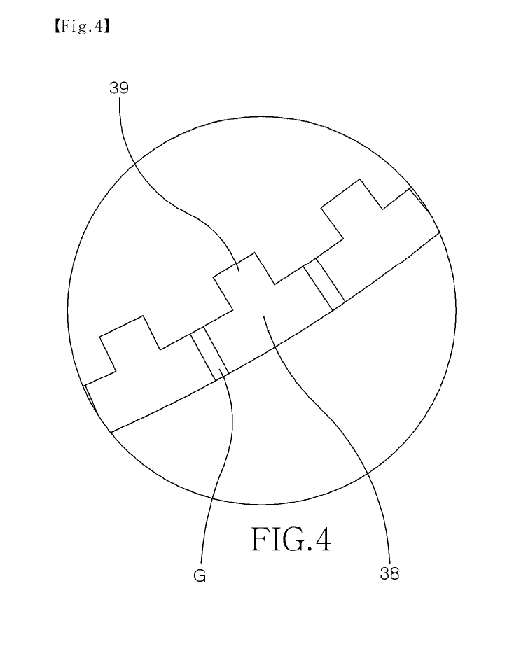

The nodes 38 are described in more detail with reference to FIG. 4. Referring to FIG. 4, the nodes 38 may have projections 39 protruding in the extension direction of the dental acquisition frame 30 and inward perpendicular to the nodes. That the nodes 38 may have a T-shaped structure.

That is, the dental acquisition frame 40 is held by all of the T-shaped structures of the nodes 38. According to the present invention, the dental acquisition film 40 is firmly fixed by the protrusions 39 and the dental acquisition film 40 can be accurately deformed to fit the dental impression of a patient.

As compared with nodes without a protrusion, when the dental acquisition film 40 is held by the dental acquisition frame 30, the areas holding the dental acquisition film 40 are large, so the dental acquisition frame 30 can more strongly hold the dental acquisition film 40.

When seen from above, the length of the protrusions 39 may be substantially the same as the width of the nodes of the dental acquisition frame 30 (the longitudinal length of the protrusions 39). When the protrusions 39 are too thick, the adjacent protrusions 39 may hit against each other and break while the dental acquisition frame 30 is distorted, or they may interfere with smooth twisting of the dental acquisition frame 30. On the contrary, when the protrusions 39 are too thin, the areas for holding the dental acquisition film 40 are not sufficiently secured, so the dental acquisition film 40 may be separated.

The insides of the protrusions 39 in which the dental acquisition film 40 is inserted may be empty so that the protrusions 39 smoothly hold the dental acquisition film 40 and unnecessary weigh is reduced.

Another embodiment of the present invention is described hereafter with reference to FIG. 6. In this embodiment of the present invention, detailed description of the same configuration as that of the previous embodiment is not provided.

FIG. 6 is a view showing a dental impression acquisition tray 10′ according to another embodiment of the present invention. In the dental impression acquisition tray 10′ according to the present embodiment, a dental acquisition frame 30′ may extend in two directions from a handle 20. That is, as compared with the dental acquisition frame 30 of the previous embodiment, it may have a symmetric structure extending from the center line of the handle 20.

The dental impression acquisition frame 30 may be composed of a first part 32′ extending in tow directions from the handle 20, a second part 34′ opposite the first part 32 and having a U-shape, and a first reinforcing member 36′ and a second reinforcing member 36″ connecting the first part 32′ and the second part 34′ to each other. The dental acquisition frame 30′ of the present embodiment has a closed loop shape, unlike the previous embodiment, and a dental acquisition film 40 may be disposed in the closed space.

The first reinforcing member 36′ and the second reinforcing member 36″ may be inserted in the dental acquisition frame 30′. In detail, the first reinforcing member 36′ may be partially in the first part 32′ and the second part 34′ such that the inserted portions are not exposed, and the center portion for connecting the parts may be bent and exposed.

The first reinforcing member 36′ may be inserted by ½ or more of the entire lengths of the first part 32′ and the second part 36′. Further, at least the reinforcing member 36′ may not be disposed at the middle portion of the second part 34′.

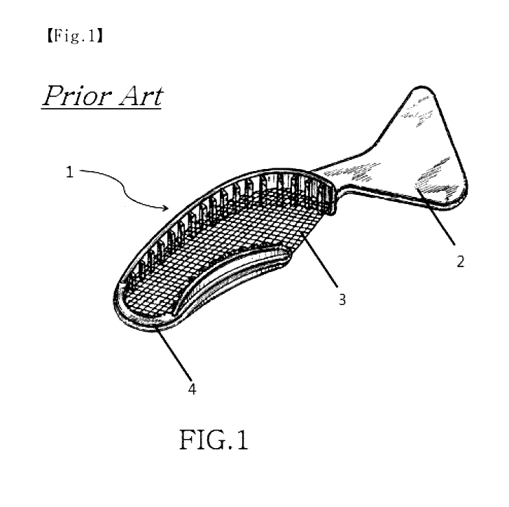

The first part 32′ and the second part 34′ of the dental acquisition frame 30′ may have a core where the first reinforcing member 36′ and the second reinforcing member 36′ are inserted and a plurality of nodes divided by a plurality of grooves on both sides of the core. The detailed structures of the first part 32′ and the second part 34′ shown in FIG. 6 are substantially the same as those of the first part 32 and the second part 34 described with reference to FIGS. 1 to 5.

The length of the portion of the first reinforcing member 36′ inserted in the first part 32′ may be ¼ or more of the length of the first part 32′, the length of the second reinforcing member 36″ inserted in the first part 32′ may be ¼ or more of the length of the first part 32′, the length of the portion of the first reinforcing member 36′ inserted in the second part 34′ may be ¼ or more of the length of the second part 34′, and the length of the portion of the second reinforcing member 36″ inserted in the second part 34′ may be ¼ or more of the length of the second part 34′. When the reinforcing members are inserted into fewer parts than those described above, deformation at the portions where the reinforcing members are not inserted cannot be maintained well.

The first reinforcing member 36′ and the second reinforcing member 36″ may be inserted up to nodes of the first part 32′ and the second part 34′.

The width W′ of the first parts 32′ of the dental acquisition frame 30′ may increase and decrease from a predetermined portion, as it goes away from the handle 20 in longitudinal direction of the first part 32′. The width W′ may be the largest at a position at a distance of 30-35% of the entire length of the first part 32′ from the handle 20.

In the first part 32′, the width W1 of a node on a side of the core may be different from the width W2 of a node on the other side. According to the dental impression acquisition tray 10 of the previous embodiment that acquires the impression of only one of the left and right sides in a mouth, an upper part and a lower part can be easily discriminated in accordance with which side in the mouth has been acquired, but according to the dental impression acquisition tray 10′ of the present invention, it is difficult to discriminate an upper part and a lower part. Accordingly, a difference is given between the widths of the upper part and the lower part, thereby discriminating the upper part and the lower part of the dental impression acquisition tray 10′.

Using the left-right symmetric dental impression acquisition tray 10′ is advantageous in that it is possible to simultaneously acquire the impression of the left and right sides in the patient's mouth in one process. Further, when the structure of one of the left and right sides in a mouth influences impression acquisition of the other side, it is advantageous for acquiring accurate dental impression to simultaneously acquire the impression of the left and right side, as in the present embodiment.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A dental impression acquisition tray comprising:
a handle;
a dental acquisition frame including a first part connected with the handle and a second part opposite the first part;
a reinforcing member connecting the first part and the second part to each other; and
a dental acquisition film disposed in a space inside the dental acquisition frame and covered with an impression film,
wherein the reinforcing member is partially inserted in the first part and the second part,
the reinforcing member is made of metal, and
the first part and the second part each have a core covering a portion of the reinforcing member and a plurality of nodes formed on a top and a bottom of the core, and a plurality of grooves is formed between the nodes.

2. The dental impression acquisition tray of claim 1, wherein a length of the portion of the reinforcing member inserted in the first part is ⅓ or more of a length of the first part, and
a length of the reinforcing member inserted in the second part is ⅓ or more of a length of the second part.

3. The dental impression acquisition tray of claim 1, wherein a width of the grooves is 1 mm to 3 mm in an extension direction of the first part or the second part.

4. The dental impression acquisition tray of claim 2, wherein the number of the nodes of the first part is six to eight on each of the top and the bottom of the core, and the number of the nodes of the second part is four to six on each of the top and the bottom of the core.

5. The dental impression acquisition tray of claim 4, wherein lengths of the nodes of the first part and the nodes of the second part are 0.8 cm-2 cm in an extension direction of the dental acquisition frame.

6. The dental impression acquisition tray of claim 5, wherein the nodes of the first part and the second part each have a protrusion that protrudes inward.
